(19) United States
(12) Patent Application Publication
(10) Pub. No.: US 2011/0244815 A1
(43) Pub. Date: Oct. 6, 2011

(54) INFORMATION PROCESSING APPARATUS AND WIRELESS COMMUNICATION MODULE

(75) Inventors: Anwar SATHATH, Ome-shi (JP); Toshiyuki HIROTA, Hino-shi (JP); Masao TESHIMA, Kunitachi-shi (JP); Hiroshi SHIMASAKI, Kunitachi-shi (JP)

(73) Assignee: KABUSHIKI KAISHA TOSHIBA, Tokyo (JP)

(21) Appl. No.: 13/077,564

(22) Filed: Mar. 31, 2011

(30) Foreign Application Priority Data
Mar. 31, 2010 (JP) 2010-082880

(51) Int. Cl. H01Q 21/30; H04B 1/02

(52) U.S. Cl. 455/91; 343/876

(57) ABSTRACT

According to one embodiment, an information processing apparatus includes an antenna, a wireless communication module and a switch circuit. The wireless communication module is configured to wirelessly communicate using the antenna. The wireless communication module includes a terminal to output a status indicating a state of a wireless communication. The switch circuit is configured to switch resonant frequency bands of the antenna based on the status signal.

### CROSS-REFERENCE TO RELATED APPLICATIONS

This application is based upon and claims the benefit of priority from Japanese Patent Application No. 2010-082880, filed Mar. 31, 2010, the entire contents of which are incorporated herein by reference.

### FIELD

Embodiments described herein relate generally to an antenna frequency control technique suitably used for a personal computer or the like including a wireless communication function, for example.

### BACKGROUND

In recent years, various mobile personal computers such as notebook computers have been developed. Most of the above types of mobile personal computers include wireless communication functions to execute wireless communications with an external device such as wireless WAN base stations, for example.

Further, recently, it is required to provide a wideband antenna which supports number of frequency bands used by mobile wireless communication system. However, since the mobile personal computer is limited in space, it is required to mount an antenna which has multiple elements in and a switch through which an element is selected. This antenna is, hereafter, called as reconfigurable antenna.

Generally, a mobile wireless communication function has a function which scans the frequency band now in service in an area. The scan function detect a channel to be used by sequentially checking channels in respective frequency band. When the reconfigurable antenna is mounted, it is required to switch the frequency (element) of the antenna in accordance with the frequency to be used. Therefore, the mobile personal computer on which the reconfigurable antenna is mounted as described before has to be switched to the right frequency bands to be used, without causing delay when start searching in the respective band.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the appearance of an information processing apparatus of an embodiment.

FIG. 2 is an exemplary block diagram showing the system configuration of the information processing apparatus of the embodiment.

FIG. 3 is an exemplary diagram showing an assignment example of resonant frequency bands with respect to status data output from a wireless communication module provided in the information processing apparatus of the embodiment.

FIG. 4 is an exemplary flowchart for illustrating the operation procedure of the antenna frequency control operation performed by the information processing apparatus of the embodiment.

### DETAILED DESCRIPTION

Various embodiments will be described hereinafter with reference to the accompanying drawings.

In general, according to one embodiment, an information processing apparatus includes an antenna, a wireless communication module and a switch circuit. The wireless communication module is configured to wirelessly communicate using the antenna. The wireless communication module includes a terminal to output a status indicating a state of a wireless communication. The switch circuit is configured to switch resonant frequency bands of the antenna based on the status signal.

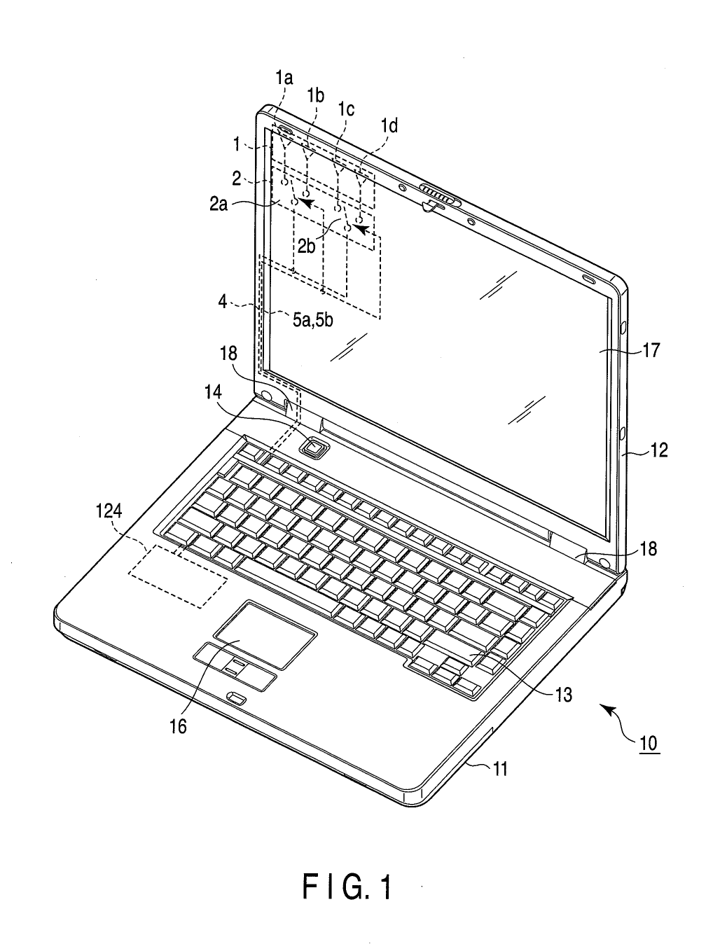

FIG. 1 shows the appearance of an information processing apparatus according to an embodiment. The information processing apparatus is realized as a mobile personal computer 10 that can be battery-driven.

FIG. 1 is an exemplary perspective view showing a state in which the display unit of the computer 10 is opened. The computer 10 is configured to include a computer main body 11 and display unit 12. In the display unit 12, a display device configured by a liquid crystal display (LCD) 17 is incorporated and the display screen of the LCD 17 is positioned in substantially the central portion of the display unit 12.

The display unit 12 is mounted to freely rotate on the computer main body 11 via hinge portions 18. The hinge portions 18 are coupling portions that couple the display unit 12 to the computer main body 11. That is, the display unit 12 is supported by use of the hinge portions 18 arranged at the rear end portions of the computer main body 11. The display unit 12 is mounted to freely rotate on the computer main body 11 by use of the hinge portions 18 between an open position in which the upper surface of the computer main body 11 is exposed and a closed position in which the upper surface of the computer main body 11 is covered with the display unit 12.

In the inner portion of the display unit 12, an antenna 1 and switch circuit 2 are provided. The antenna 1 and switch circuit 2 may function as a reconfigurable antenna that can change the resonant frequencies. That is, the antenna 1 has at least two of first and second resonant frequency bands. In this example, it is assumed that the antenna 1 has four of first to fourth resonant frequency bands. Further, the switch circuit 2 functions as a frequency switch that switches the resonant frequency band of the antenna 1 [1] between the first and second resonant frequency bands and [2] between the third and fourth resonant frequency bands.

Specifically, the antenna 1 includes [1] an antenna element 1a that covers the first resonant frequency band and an antenna element 1b that covers the second resonant frequency band and [2] an antenna element 1c that covers the third resonant frequency band and an antenna element 1d that covers the fourth resonant frequency band. Further, the switch circuit 2 switches the connection destination of a signal line 4 that is lead out from a wireless communication module 124 provided in the main body 11 into the display unit 12 via the hinge portions 18 [1] between the antenna elements 1a and 1b and [2] between the antenna elements 1c and 1d. The switch circuit 2 includes switch elements 2a, 2b and the switch elements 2a, 2b perform the antenna switching operation according to control signals supplied via signal lines 5a, 5b lead out from the internal portion of the main body 11 into the display unit 12 via the hinge portions 18.

The computer 10 is configured to rapidly perform the antenna switching operation based on a status signal indicating the execution state of wireless communication output from the wireless communication module 124 itself. This point is described in detail below.

In this case, an example in which the antenna 1 includes the four antenna elements 1a to 1d that cover the first to fourth resonant frequency bands is shown. However, the antenna 1 may be configured by two antenna elements including an antenna element that exclusively and selectively covers one of the first and second resonant frequency bands and an antenna element that exclusively and selectively covers one of the third and fourth resonant frequency bands.

In this case, for example, the resonant frequency band of the antenna 1 is switched between the first and second resonant frequency bands and between the third and fourth resonant frequency bands by changing the constants of components of an inductor (L) and capacitor (C) in each antenna element connected to the ground (GND) by use of the switch circuit 2. For example, the first and third resonant frequency bands may be selected in a period in which the switch elements 2a, 2b are set in an off state and the second and fourth resonant frequency bands may be selected in a period in which the switch elements 2a, 2b are set in an on state by control signals.

Further, the antenna 1 and switch circuit 2 may be mounted on the same substrate.

The computer main body 11 is a base unit having a thin box-shaped casing and a keyboard 13, a power button 14 which turns on/off the power source of the computer 10, a touchpad 16 and the like are arranged on the upper surface thereof. Further, in the internal portion of the computer main body 11, a system board (which is also called a mother board) on which various electronic components are mounted is provided. On the system board, the wireless communication module 124 described before is provided.

The wireless communication module 124 is a module that executes wireless communications with the external device according to a third-generation (3G) mobile communication system, for example. In the 3G mobile communication system, for example, the 850-, 900-, 1900- and 2100-MHz bands are used. The 850- and 1900-MHz bands are used in, for example, the U.S.A. and Japan, and the 900- and 2100-MHz bands are used in, for example, Europe. In this case, the antenna element 1a covers the 850-MHz band (first resonant frequency band), the antenna element 1b covers the 900-MHz band (second resonant frequency band), the antenna element 1c covers the 1900-MHz band (third resonant frequency band) and the antenna element 1d covers the 2100-MHz band (fourth resonant frequency band).

For example, the mounting position of the antenna 1 is set at the upper end portion in the display unit 12. The wireless communication module 124 can execute wireless communications with the external device in a state in which the antenna 1 is arranged in a relatively high position by mounting the antenna 1 on the upper end portion in the display unit 12.

For example, the signal line 4 is configured by a cable such as a coaxial cable and is passed through a space in the internal portion of the hinge portion 18. Likewise, each of the signal lines 5a, 5b is configured by a cable and is passed through a space in the internal portion of the hinge portion 18. The cables are lead out from the computer main body 11 to the display unit 12 via the hinge portions 18.

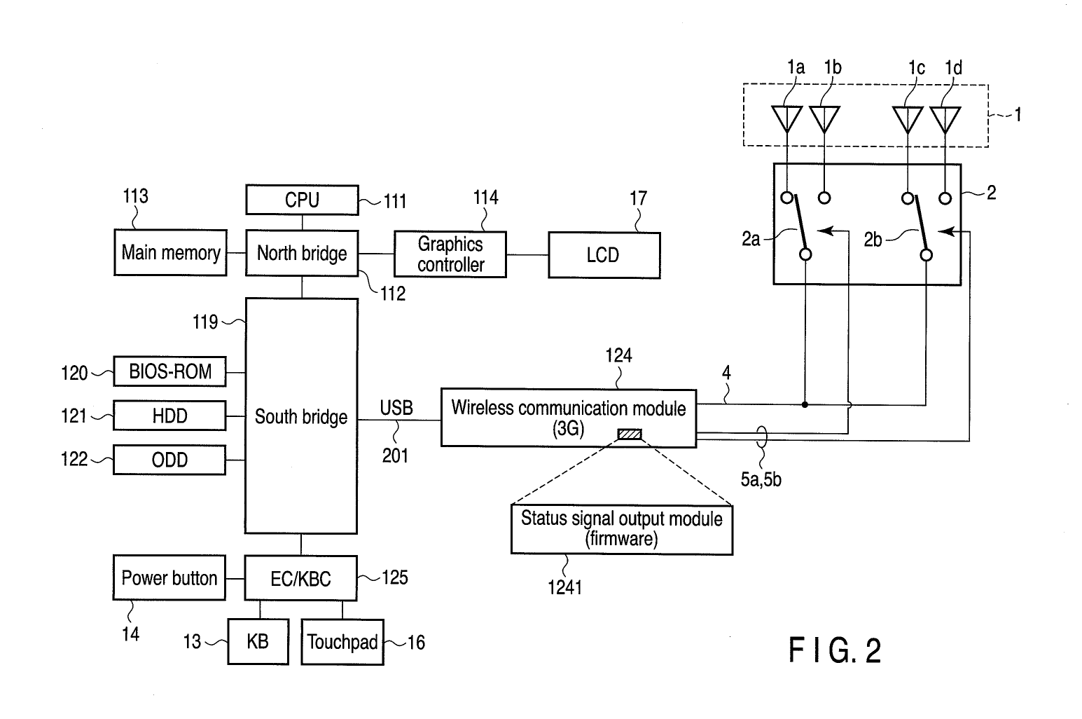

Next, the system configuration of the computer 10 is explained with reference to FIG. 2.

As shown in FIG. 2, the computer 10 includes a CPU 111, north bridge 112, main memory 113, graphics controller 114, south bridge 119, Basic Input/Output System (BIOS) read-only memory (ROM) 120, hard disk drive (HDD) 121, optical disc drive (ODD) 122, wireless communication module 124, EC/KBC 125 and the like.

The CPU 111 is a processor that controls the operation of the computer 10 and executes an operating system (OS) that performs resource management and various application programs including a utility program executed under the OS control, which are loaded from the HDD 121 and ODD 122 to the main memory 113. Further, the CPU 111 executes a BIOS stored in the BIOS-ROM 120. The BIOS is a program for hardware control.

The north bridge 112 is a bridge device that connects the local bus of the CPU 111 to the south bridge 119. The north bridge 112 includes a function of performing communication with the graphics controller 114 via an accelerated graphics port (AGP) bus.

The graphics controller 114 is a display controller that controls the LCD 17 used as a display monitor of the computer 10. The south bridge 119 is a device that controls various I/O devices. The south bridge 119 is connected to the wireless communication module 124 via a bus 201 such as a Universal Serial Bus (USB), for example.

The wireless communication module 124 includes an antenna terminal used for transmitting and receiving a radio frequency (RF) signal and first and second output terminals to output status signals each indicating one of the resonant frequency bands used. The antenna terminal of the wireless communication module 124 is connected to the antenna 1 via the signal line 4 (via the switch circuit 2). Further, the first and second output terminals of the wireless communication module 124 are connected to the switch circuit 2 via the signal lines 5a, 5b. The wireless communication module 124 further includes a status signal output module 1241 that outputs status signals from the first and second output terminals. The status signal output module 1241 is configured as updatable firmware configured by storing a program in the flash memory in the wireless communication module 124.

The EC/KBC 125 is a single-chip microcomputer in which a built-in controller for power management and a keyboard controller used for controlling the keyboard (KB) 13 and touchpad 16 are integrated. The EC/KBC includes a function of turning on/off the power source of the computer 10 according to the operation of the power button 14.

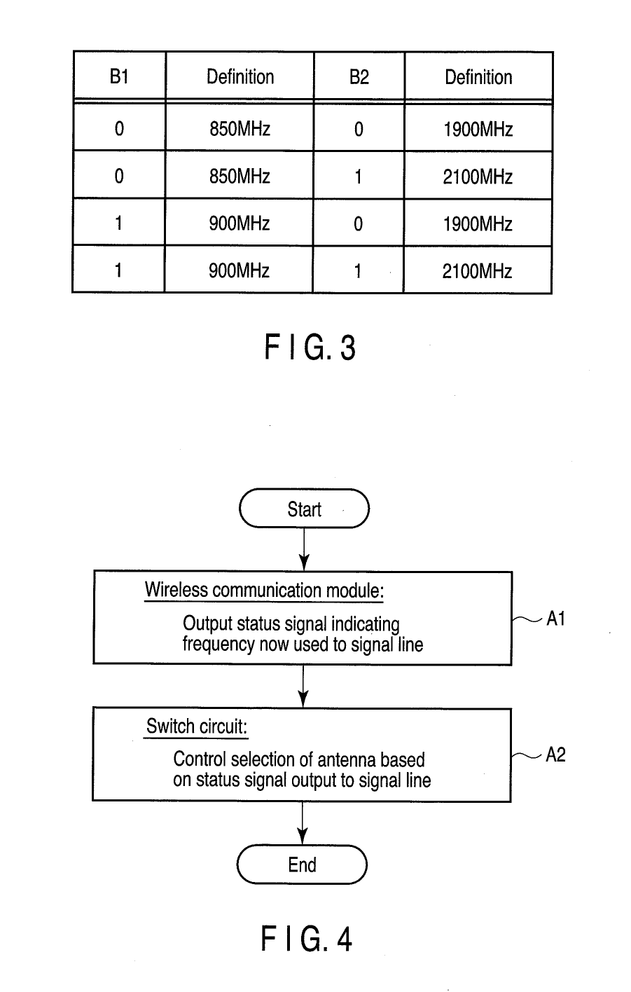

FIG. 3 is an exemplary diagram showing an assignment example of resonant frequency bands with respect to status signals output from the first, second output terminals of the wireless communication module 124 by use of the status signal output module 1241.

In FIG. 3, B1 is a signal output from the first output terminal of the wireless communication module 124 and supplied to the switch circuit 2 via the signal line 5a (for switching control of the switch element 2a). Further, B2 is a signal output from the second output terminal of the wireless communication module 124 and supplied to the switch circuit 2 via the signal line 5b (for switching control of the switch element 2b).

As shown in FIG. 3, the status signal output module 1241 outputs a status signal indicating one of an 850- and 900-MHz band expressed by a one-bit low (0)/high (1) value from the first output terminal and outputs a status signal indicating one of a 1900- and 2100-MHz band expressed by a one-bit low (0)/high (1) value from the second output terminal. The above status signals are supplied to the switch circuit 2 as control signal as they are and switching operations are performed by use of the switch elements 2a, 2b as required.

That is, in the computer 10, for example, it is unnecessary to decode the control signal (relating to the antenna) on the switch circuit 2 side. Further, the status signal output module 1241 configured as firmware in the wireless communication module 124 that executes wireless communication outputs the status signals from the first, second output terminals of the wireless communication module 124. Therefore, even when the wireless communication module 124 performs the search function of determining which one of the channels is to be used, the antenna switching operation can be rapidly performed without causing a delay. That is, in the computer 10, the switching operation for the antenna 1 can be instantly performed according to the execution state of wireless communication by the wireless communication module 124.

For example, if the computer 10 is used in the U.S.A. or Japan, the 850- and 1900-MHz bands are selected by the search operation of the wireless communication module 124 and status signals of B1:0 and B2:1 are output from the status signal output module 1241. Further, for example, if the computer is used in Europe, the 900- and 2100-MHz bands are selected and status signals of B1:1 and B2:1 are output. In either case, status signals indicating the resonant frequency bands to be checked are instantly output from the status signal output module 1241 at the operation time of the search function of the wireless communication module 124. As a result, the switching operation for the antenna 1 can be instantly performed.

FIG. 4 is an exemplary flowchart for illustrating the operation procedure of the antenna frequency control operation performed by the computer 10.

First, the status signal output module 1241 configured as firmware in the wireless communication module 124 outputs status signals indicating the resonant frequency bands now used for wireless communication by the wireless communication module 124 from the first, second output terminals of the wireless communication module 124 (block A1).

Then, the switch circuit 2 performs the switching operation for the antenna by use of the switch elements 2a, 2b based on the status signals (block A2).

Thus, according to the computer 10, the resonant frequency bands of the antenna can be instantly switched according to the execution state of wireless communication.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an antenna;
a wireless communication module configured to wirelessly communicate using the antenna, the wireless communication module comprising a terminal configured to output a signal indicating a wireless communication setting; and
a switch configured to switch resonant frequency bands of the antenna based on the signal.

2. The apparatus of claim 1, wherein:
the antenna is configured to cover first and second resonant frequency bands; and
the signal indicates which one of the first and second resonant frequency bands is to be used.

3. The apparatus of claim 2, wherein the signal comprises one-bit data expressing a first or second setting, and the first and second settings correspond to the first and second resonant frequency bands, respectively.

4. The apparatus of claim 2, wherein the wireless communication module comprises a search processor configured to search the first and second resonant frequency bands for an in-service resonant frequency and to determine which one of the first and second resonant frequency bands is to be used, and the signal indicates which resonant frequency band is being searched for.

5. The apparatus of claim 1, wherein:
the antenna covers first, second, third, and fourth resonant frequency bands and
the terminal is configured to output a first signal and a second signal, the first signal indicating which one of the first and second resonant frequency bands is to be used, the second signal indicating which one of the third and fourth resonant frequency bands is to be used.

6. The apparatus of claim 1, further comprising:
a main body comprising the wireless communication module; and
a display on the main body configured to freely rotate,
wherein the display houses the antenna and the switch.

7. The apparatus of claim 6, wherein the display is connected to the main body via a coupling portion, and
a signal line connecting the terminal of the wireless communication module to the switch is lead out from the main body to the display via the coupling portion.

8. The apparatus of claim 1, wherein:
the antenna is configured to cover a plurality of resonant frequency bands; and
the signal indicates which one of the plural resonant frequency bands is to be used.

9. The apparatus of claim 8, wherein the wireless communication module comprises a search processor configured to search the plural resonant frequency bands for an in-service resonant frequency and to determine which one of the resonant frequency bands is to be used, and the signal indicates which resonant frequency band is being searched for.

10. A wireless communication module that wirelessly communicates using a first resonant frequency band and wirelessly communicates using a second resonant frequency band, comprising:
a terminal to output a signal indicating which one of the first resonant frequency band and the second resonant frequency band is to be used.

11. The module of claim 10, further comprising:
a search processor configured to check the first resonant frequency band and the second resonant frequency band and to determine which one of the first resonant frequency band and the second resonant frequency band is to be used; and
an output module configured to output a signal indicating which resonant frequency band is being checked.
